(19) United States
(12) Patent Application Publication
(10) Pub. No.: US 2013/0216297 A1
(43) Pub. Date: Aug. 22, 2013

(54) FASTENING APPARATUS

(71) Applicant: NEWFREY LLC, (US)

(72) Inventor: Jens ALBACH, Giessen (DE)

(73) Assignee: NEWFREY LLC, Newark, DE (US)

(21) Appl. No.: 13/768,122

(22) Filed: Feb. 15, 2013

(30) Foreign Application Priority Data
Feb. 17, 2012 (DE) 102012003337.0

(51) Int. Cl. F16B 19/00

(52) U.S. Cl. CPC F16B 19/00
USPC 403/20

(57) ABSTRACT

A fastening apparatus for fastening to a spherical stud affixed to a workpiece, the fastening apparatus removable from the stud with an unlatching tool, and the fastening apparatus comprises: an inner sleeve, which can splay out in the radial direction and can be slid over the stud; an outer sleeve axially slidable over the inner sleeve into a fastening position; and a latching device for releasably joining the outer sleeve to the inner sleeve in the fastening position, the latching device including a latching tongue which engages a latching shoulder in the fastening position, thus forming a latched connection; and wherein the fastening apparatus further comprises a tool access for insertion of the unlatching tool operable to disengage the latching tongue from the latching shoulder.

### CROSS-REFERENCE TO RELATED APPLICATION

This application claims priority from German Patent Application No. DE 102012003337.0, filed on Feb. 17, 2012, the disclosure of which is incorporated herein by reference.

### BACKGROUND OF THE INVENTION

The present invention relates to a fastening apparatus for fastening to a spherical stud, in particular a ball stud, having an inner sleeve, which can splay out in the radial direction and can be slid onto the stud, and having an outer sleeve, which can be slid over the inner sleeve in an axial direction into a fastening position, the outer sleeve being releasably fastenable to the inner sleeve in the fastening position by means of a latching device.

A fastening apparatus of this type is known from document DE 32 32 926 C2 and can be used to fasten component parts. The spherical stud can be fixed to one of the component parts. At least one further component part can be fixed to the first component part by means of the fastening of the fastening apparatus to the spherical stud.

In the known fastening apparatus described above, the inner sleeve is formed as a collet which is designed to engage, from behind, an end part of the stud, said end part being undercut in the direction of fitting. The outer sleeve is formed as a locking part which can be fitted onto the collet. At the front end parts of the locking part and of the collet, cooperating latching means are provided which are formed as circumferential latching ribs and latching grooves. In one variant, the latching means can be designed so as to be releasable. It is not possible to achieve high retaining forces in this variant. In a further variant, the latching means thus have flanks which are so steep that the latched connection to be achieved is unreleasable. In this case, high retaining forces can be achieved. However, fastening apparatuses in this variant can only be disassembled in a destructive manner.

### BREIF DESCRIPTION OF THE INVENTION

On this basis, the object of the invention is to provide an improved fastening apparatus with which high retaining forces of a fastening arrangement formed therewith can be achieved and which can still be disassembled without destruction.

This object is achieved with the fastening apparatus described in the introduction in that the latching device has at least one latching tongue which engages, from behind, a latching shoulder in the fastening position, thus forming a latched connection which is secured against release, at least one tool access portion being provided on the outer sleeve and/or on the inner sleeve, a tool for releasing the latched connection being guidable through said tool access portion.

The latched connection is consequently formed by the cooperation between at least one latching tongue and a corresponding latching shoulder. Due to the steepness of their flanks, the latching tongue and/or the latching shoulder are formed in such a way that it is possible to form a latched connection secured against release. The latching tongue and/or the latching shoulder preferably do not extend over the entire circumference of the fastening apparatus. The latching tongue and/or the latching shoulder should preferably extend over an angular range of less than 90°, in particular less than 60°, preferably less than 45°.

The ability of the inner sleeve to splay out radially can preferably be implemented by introducing at least one axial slit into the inner sleeve, said axial slit preferably extending over at least 60% of the axial length of the inner sleeve.

The inner sleeve and the outer sleeve can be provided as separate component parts. Furthermore, it may be possible to pre-assemble the inner sleeve and the outer sleeve, for example a further latching recess being provided for preassembly, in which the latching tongue can engage.

The inner sleeve and outer sleeve are particularly preferably provided in one piece however, the inner sleeve and the outer sleeve being axially offset with respect to one another and being connected in an axially small region of overlap via a connecting portion which can be separated, in particular by applying an axial force between the inner sleeve and the outer sleeve.

It is advantageous if the fastening apparatus is formed in one part or integrally in the pre-assembled state.

High retaining forces can be achieved as a result of the latched connection, which is established in the fastening position between the latching tongue and the latching shoulder. It is still possible, via the tool access portion, to release the latched connection so as to disassemble the fastening apparatus, in particular to detach the outer sleeve from the inner sleeve, the inner sleeve and the outer sleeve not being damaged at all or substantially during this process.

For example, a screwdriver or a similar tool may be used as a tool in this instance and is guided through the tool access portion and bends the latching tongue away radially so as to release the latched connection.

The fastening apparatus preferably has two latching tongues which are diametrically opposed in the radial direction and two latching shoulders which are accordingly diametrically opposed. A tool for releasing the latched connection preferably has two tool tips which are preferably introduced at the same time into suitable tool access portions so as to simultaneously force the two latching tongues away and so as to simultaneously release the two latched connections formed thereby.

The fastening apparatus is preferably formed in such a way that the extent to which the inner sleeve can be splayed out in the radial direction is restricted when the outer sleeve is slid over the inner sleeve so as to thus establish a positive connection in the axial direction between the spherical stud and the inner sleeve. A positive connection in the axial direction between the inner sleeve and the outer sleeve is also established by the latched connection, and therefore high retaining forces can be achieved.

The inner sleeve and/or the outer sleeve are preferably formed of a plastics material and are preferably produced by an injection moulding method. In the case of a one-part fastening apparatus, the separable connecting portion between the outer sleeve and the inner sleeve may be formed by one or more thin webs between the inner sleeve and the outer sleeve.

The object is thus achieved completely.

According to a particularly preferred embodiment, the latching tongue is formed on the inner sleeve and/or the latching shoulder is formed on the outer sleeve.

In this case it is advantageous if, in a relaxed position, the latching tongue can extend beyond the outer circumference of the inner sleeve so that it is relatively easy to slide the outer sleeve over the inner sleeve and to thus press the latching tongue radially inwardly until it ultimately engages, from behind, a latching shoulder on the inner circumference of the outer sleeve. In this embodiment a tool access portion can also be formed in a relatively simple manner, in particular by a central opening in the outer sleeve.

According to a further preferred embodiment, the tool access portion has an axial recess on an inner circumference portion of the outer sleeve.

A tool can thus be guided through the axial recess and into the region of the latched connection.

According to a particularly preferred embodiment, the axial recess extends from one axial end of the outer sleeve (in particular an upper end) to the latching shoulder, which is preferably formed on the inner circumference of the outer sleeve.

The outer sleeve and the fastening apparatus formed therewith can thus be formed in a structurally simple manner.

According to a further preferred embodiment, the tool access portion has a radial recess on the outer circumference of the latching tongue.

It is thus possible, in particular in combination with an axial recess on the inner circumference of the outer sleeve, to guide a tool towards the latched connection. Owing to a recess of this type, the latching tongue can also be grasped securely so as to be pressed back and so as to thus release the latched connection.

According to a further embodiment, the latching tongue is formed on the outer sleeve and/or the latching shoulder is formed on the inner sleeve.

In particular, it is advantageous in this variant if the tool access portion has an axial recess in the inner sleeve.

The outer sleeve is preferably connected to a fastening portion. The fastening portion may have an annular collar portion extending radially outwardly with respect to the outer circumference of the outer sleeve in order to fix a planar second component part, such as a cladding part or a carpet portion, to a planar first component part, to which a spherical stud is fixed.

According to a further preferred embodiment, the fastening portion has a lower part and an upper part, which are interconnected by a hinge.

In this embodiment it is possible to provide receptacles for elongate objects between the lower part and the upper part. The outer sleeve is preferably a component part of the lower part. In this case, a recess may likewise be provided in the upper part so as to introduce therethrough a tool for releasing the latched connection.

It is generally preferred to introduce a tool into the outer sleeve via an axial central opening. If necessary, the central opening may be closed by a removable plug or the like.

According to a further embodiment, the tool access portion may also have a radial recess in the outer sleeve. This may be advantageous in terms of structure if the outer circumference of the outer sleeve is accessible, radially outwardly, in the fastening position.

According to a further, all in all preferred, embodiment, the inner sleeve and the outer sleeve can be interconnected in a non-rotational manner by means of an anti-twist protection device.

It can thus be ensured that the outer sleeve can only be slid axially onto the inner sleeve in one specific relative rotary position. In this one position, the latching tongue is oriented with the latching shoulder in the direction of rotation. In any case, the latched connection is consequently produced when the outer sleeve is slid on axially.

The anti-twist protection device is preferably formed in such a way that the inner sleeve and outer sleeve cannot, under any circumstance, be inserted into one another in a rotary position other than the predetermined rotary position, so as to thus prevent incorrect assembly.

The anti-twist protection device is preferably formed by a first anti-twist protection portion on the outer sleeve and by a second anti-twist portion on the inner sleeve, at least one of the two anti-twist protection portions extending in the axial direction.

A fastening arrangement can be formed by means of the fastening apparatus, a first and second component part being fixed to one another in said fastening arrangement and the spherical stud being fixed to one of the component parts.

A spherical stud is preferably to be understood to mean a rotationally symmetrical stud. This may be smooth at its outer circumference, or furrowed or the like. The spherical stud may be produced from a metal material so as to join the stud to a metal first component part, for example by means of stud welding. However, the stud may also be produced from a plastics material, in which case the first component part may likewise be produced from plastics material. Different joining methods, such as stud welding, bonding or thermowelding, are suitable for joining the stud to the first component part.

In the present case, a spherical stud is also understood to mean any type of stud which has a greater diameter in a centre region compared to a region adjacent to a joining face, with which the stud is joined to a first component part, in such a way that a radial undercut is provided between the centre region and the first component part. The spherical stud may be spherical or partly spherical in longitudinal section, but may also be shaped elliptically in longitudinal section or have an angular shape, such as a T-stud, which has a narrow shaft portion and a head portion of greater diameter which is grasped by a receptacle in the inner sleeve. In the latter case, the spherical receptacle may also be angular in longitudinal section.

The fastening apparatus is preferably used in the field of body construction of motor vehicles, for example to fasten cladding parts to bodywork portions or to fasten elongate second component parts to bodywork portions, the spherical stud preferably being joined to the bodywork portion.

It is understood that the features described above and those yet to be explained hereinafter can not only be used in the respective combinations disclosed, but can also be used in other combinations or alone, without departing from the scope of the present invention.

### BRIEF DESCRIPTION OF THE VIEW OF THE DRAWINGS

Exemplary embodiments of the invention are illustrated in the drawing and will be explained in greater detail in the description below. In the drawing:

FIG. 1 shows a perspective view of a first embodiment of a fastening apparatus according to the invention in a pre-assembled position;

FIG. 2 shows a longitudinal sectional view through a fastening arrangement with the fastening apparatus of FIG. 1 in the pre-assembled position;

FIG. 3 shows the fastening arrangement of FIG. 2 in the fastening position;

FIG. 4 shows a half sectional view of a further embodiment of a fastening apparatus according to the invention; and

FIG. 5 shows a perspective view of a further embodiment of a fastening apparatus according to the invention in a pre-assembled position.

### DESCRIPTION OF THE PREFERRED EMBODIMENT

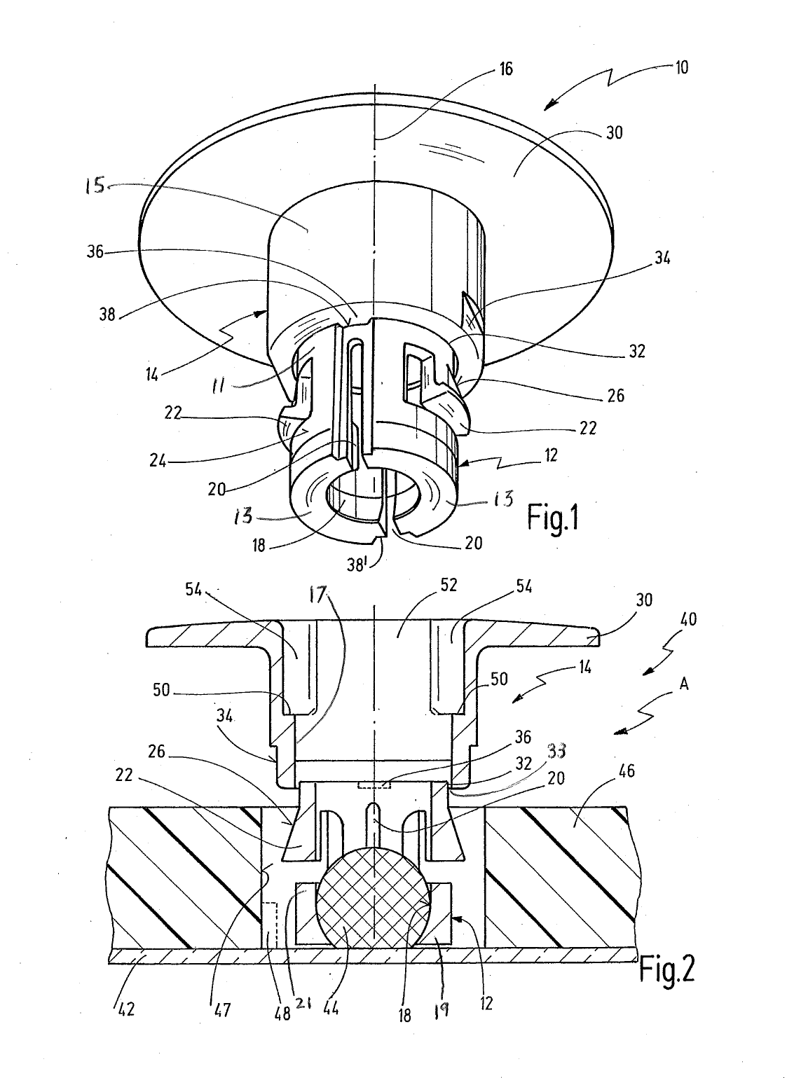

A first embodiment of a fastening apparatus according to the invention is illustrated in FIG. 1 and is denoted generally by 10.

The fastening apparatus 10 has an inner sleeve 12 and an outer sleeve 14, which are arranged concentrically with respect to a longitudinal axis 16.

At its axial end, the inner sleeve 12 comprises a spherical receptacle 18 for a spherical member, such as a spherical stud, in particular a ball stud. The spherical receptacle 18 is formed in such a way that the inner circumference of the inner sleeve 12 is smaller in the region of this axial end 19 than in a (centre) portion 21 spaced axially therefrom. The inner sleeve 12 further has at least one, in the present case two, slits 20, which are diametrically opposed in the radial direction and which extend from the aforementioned axial end. The hollow semi-cylindrical portions 13 thus formed can be expanded resiliently with respect to one another in the radial direction owing to the longitudinal slits 20.

The inner sleeve 12 further comprises at least one, in the present case two, latching tongues 22, which are radially diametrically opposed and protrude radially in the relaxed state with respect to an outer circumference 24 of the inner sleeve 12. The latching tongues 22 can be deflected radially inwardly in such a way that the outer sleeve 14 can be slid over the inner sleeve 12. For this purpose, the latching tongues 22 may each comprise a bevel 26 on their radial outer side so as to facilitate the sliding-on of the outer sleeve 14.

At an axial end remote from the inner sleeve 12, the outer sleeve 14 has a fastening portion 30 for fastening a component part. In the present case, the fastening portion 30 is formed by an annular disc-like collar, which protrudes in the radial direction with respect to an outer circumference (not described in greater detail) of the outer sleeve 14.

The inner sleeve 12 and the outer sleeve 14 can be provided as separate component parts. However, the inner sleeve 12 and the outer sleeve 14 are preferably pre-assembled together so as to enable easier handling of the fastening apparatus 10. In the present case, the inner sleeve 12 and the outer sleeve 14 are interconnected by a separable connecting portion 32. The inner sleeve 12 and the outer sleeve 14 are preferably produced from plastics material in this instance, more specifically as a single element which is preferably produced in an injection moulding method. The connecting portion 32 can be formed by a circumferential, thin, separable web 33, or by a single individual web 33 or a plurality of individual webs 33 distributed over the circumference and interconnecting the inner sleeve 12 and the outer sleeve 14.

One or more radial recesses 34 can also be provided at the outer circumference 15 of the outer sleeve 14 and, for example, may perform the function of an anti-twist protection and/or may be used for attachment of a tool. For example, the radial recesses 34 may be used for positioning in an automatic assembly machine, in particular if the outer part 14 and the inner part 12 are produced separately and are pre-assembled together retroactively in an automated manner.

FIG. 1 also shows a first anti-twist protection portion denoted by 36 and is formed in the region of the inner circumference 17 of the outer sleeve 14 in the form of a protrusion 36 which is approximately trapezoid in cross-section in the present case. A second anti-twist protection portion 38 is also formed on the outer circumference 11 of the inner sleeve 12 and is formed in the present case as an elongate groove 38 in which the first anti-twist protection portion 36 engages. The elongate groove forming the second anti-twist protection portion 38 is preferably aligned with the slit 20. It is generally possible for only one anti-twist protection device to be distributed over the circumference. However, two anti-twist protection devices of this type are preferably provided, each having first anti-twist protection portions 36, 38, which are diametrically opposed. For example, in FIG. 1 a further elongate groove 38′ is diametrically opposed with respect to the elongate groove 38 forming the second anti-twist protection portion and is aligned with the opposed slit 20.

The protrusion forming the first anti-twist protection portion 36 can preferably also perform the function of the separable connection 32 and web 33. For example, the inner sleeve 12 and the outer sleeve 14 can be interconnected via one or two such protrusions, the protrusion being separated at its radially inward end when the outer sleeve 14 is slid onto the inner sleeve 12. The protrusion can thus perform the function of the first anti-twist protection portion 36 when the outer sleeve 14 is subsequently slid onto the inner sleeve 12. As a result of the anti-twist protection device thus established, the outer sleeve 14 can only be slid onto the inner sleeve 12 in one specific relative rotary position, thus ensuring that the respective latching tongues 22 are aligned with the latching shoulders 50.

The operating principle of the fastening apparatus 10 of FIG. 1 and a method for producing a fastening arrangement will now be explained with reference to FIGS. 2 and 3. FIG. 2 shows such a fastening arrangement 40 in a pre-assembled position A.

The fastening arrangement 40 comprises a first component part 42 which is formed, for example, as a planar component part such as a bodywork sheet. A spherical stud in the form of a ball stud 44 is joined to a surface of the first component part 42, for example by a stud welding method, by a bonding method or by another joining method.

A second component part 46 is placed on the same side of the first component part 42 and may likewise be formed as a planar component part, for example in the form of a cladding element or the like. The second component part 46 has a through bore 47 which is continuous and is preferably circular in cross-section. The second component part 46 is placed on the first component part 42 in such a way that the stud 44 lies within the bore 47, preferably concentrically therewith. A radially protruding portion (key) 48 may optionally be formed on the inner circumference of the recess 47 and, for example, may engage with the radial recess 34 so as to achieve anti-twist protection in a fastening position.

In FIG. 2, which shows a longitudinal section through the fastening apparatus 10 of FIG. 1, it can be seen that at least one latching shoulder 50 is provided on the inner circumference 17 of the outer sleeve 14, the number of latching shoulders 50 corresponding to the number of latching tongues 22. In the preassembled position A shown in FIG. 2, the latching shoulders 50 are aligned with the latching tongues 22 in plan view.

The outer sleeve 14 has an axially continuous central opening 52.

In order to establish the pre-assembled position A shown in FIG. 2, the fastening apparatus 10 is placed over the ball stud 44 and then an axial pressure is exerted onto the connecting apparatus 10 towards the first component part 42. The inner sleeve 12 is thus splayed out radially in the region of the spherical receptacle 18 and then closes again resiliently around the ball stud 44 radially, as illustrated in FIG. 2. The end portion 19 of the spherical receptacle 18 engages (undersuts), from behind, a lower portion of the ball stud 44. To produce a fastening position B, as illustrated in FIG. 3, pressure is further exerted into the outer sleeve 14. The pre-assembled position A of the fastening apparatus 10 is thus released, and in particular the web 33 is broken and separable connecting portion 32 is separated so that the outer sleeve 14 is slid over the inner sleeve 12 in the axial direction, whilst the latching tongues 22 are deflected radially inwardly until they finally spring back resiliently and engage the latching shoulders 50 from behind, as illustrated in FIG. 3. A lower portion of the outer sleeve 14 engages around portion 19 of the inner sleeve 12, in which the spherical receptacle 18 is formed. As a result of this circumferential engagement, the inner sleeve 12 is consequently prevented from splaying out in this region 19. As a result of the undercut by portion 19 of the spherical receptacle 18 at the ball stud 44, a positive and/or non-positive connection between the ball stud 44 and the inner sleeve 12 in the axial direction is consequently established. Owing to the latched connection 53, which is established by the latching of the latching tongues 22 behind the latching shoulders 50, a positive connection between the inner sleeve 12 and the outer sleeve 14 is also established, and therefore the fastening apparatus 10 is fitted to the ball stud 14 in the fastening position B shown in FIG. 3 with a high retaining force. The second component part 46, which is not illustrated in FIG. 3 for reasons of clarity, is consequently fixed axially between the first component part 42 and the fastening portion 30 in the form of the annular disc-like collar, high retaining forces being provided by the fastening apparatus 10 as a result of the above-described connection between the stud pin 44, inner sleeve 12 and outer sleeve 14.

In addition, as discussed below, the latched connection 53 can also be released again so as to thus disassemble the fastening apparatus 10 with no damage at all, or no considerable damage.

In the present case, the outer sleeve 14 has at least one axial recess 54 on its inner circumference, it being possible to attach a tool via said recess so as to release the latched connection 53. The axial recess 54 extends from the outer axial end of the outer sleeve 14, down to the respective latching shoulder 50.

In addition or alternatively to this, the latching tongues 22 can be provided on their outer face with a radial recess 56, as shown in FIG. 3. In both cases a tool access portion 58 is formed, it being possible to introduce a tool via the axial recess 54 and/or the radial recess 56 so as to deflect the latching tongues 22 radially so as to thus release the latched connection 53. In the present case, a special tool for this could have two axial pin-like prolongations which are introduced simultaneously into the diametrically opposed tool access portions 58 so as to press together both latching tongues 22 at the same time and consequently release the latched connections 53.

As soon as the latched connection(s) 53 has/have been released, the outer sleeve 14 can be removed from the inner sleeve 12. The inner sleeve can then also be removed from the ball stud 44 since the inner sleeve 12 can splay out again in the region of the receptacle 18.

With the parts disassembled in this manner, assembly can take place again, for example once the second component part 46 has been replaced, the inner sleeve 12 first being placed over the ball stud 44 and the outer sleeve 14 then being positioned over the inner sleeve 12 and then slid thereon axially, as in the above-described method, too.

To release the latched connection 53 shown in FIG. 3, it is alternatively also possible to provide on the outer sleeve 14 a radial recess in the form of an opening 60 which lies at the height of the latched tongue 22 and is illustrated in FIG. 3 by dashed lines. An embodiment of this type is suitable if access to the outer circumference of the fastening apparatus 10 is possible in the fastening position B.

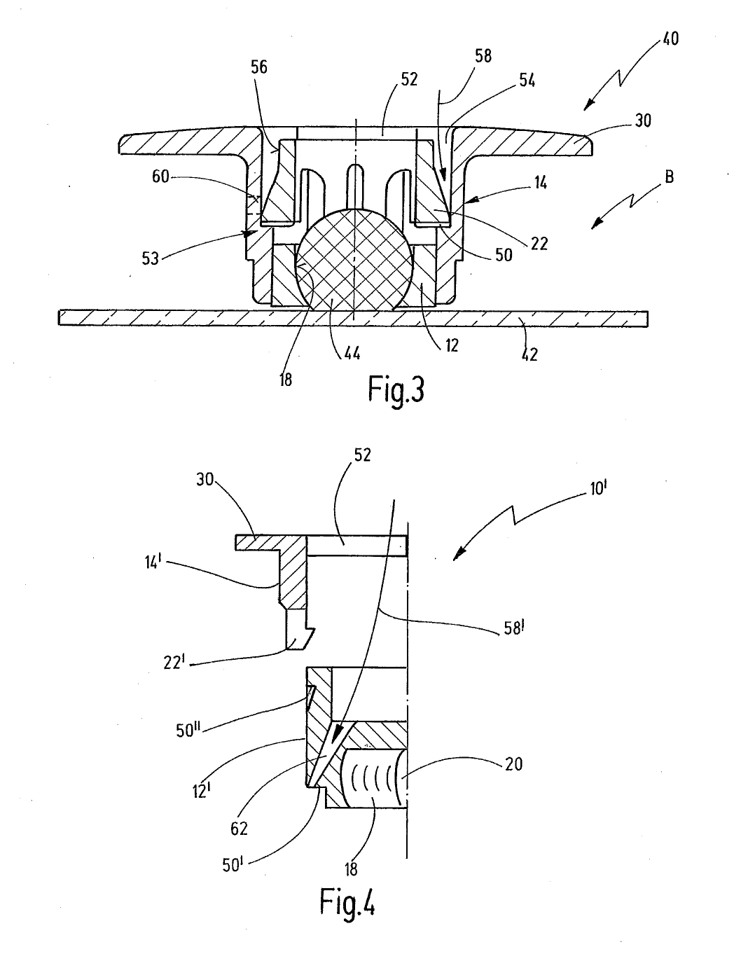

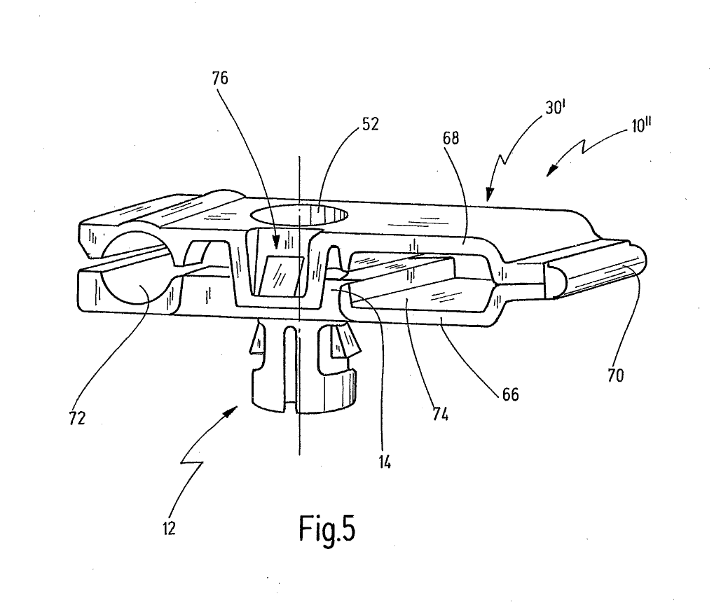

Further embodiments of fastening apparatuses are described in FIGS. 4 and 5 below and correspond generally to the fastening apparatus 10 of FIGS. 1 to 3 in terms of structure and operating principle. Like elements are therefore denoted by like reference signs. The main differences will be explained hereinafter.

In the case of the fastening apparatus 10′ shown in FIG. 4, the outer sleeve 14′ is provided at one axial end with at least one radially deflectable latching tongue 22′. A latching shoulder 50′ is formed accordingly at one axial end of the inner sleeve 12′, the latching tongue 22′ engaging in said latching shoulder in the fastening position B. It is understood that the latching tongue 22′ and the latching shoulder 50′ should be designed in such a way that sufficient circumferential forces can still be exerted by the outer sleeve 14′ so as to prevent the inner sleeve 12′ from splaying out in the fastening position. In this case, the inner sleeve 12′ may have an axial recess 62 for example, via which a tool can be introduced so as to release a latched connection produced by the latching tongue 22′ and the latching shoulder 50′. The corresponding tool access portion is denoted by 58′ in FIG. 4. FIG. 4 further shows that, in this case, a further latching recess 50″ can be provided on the outer circumference of the inner sleeve 12′ so as to establish a pre-assembled position A between the outer sleeve 14′ and the inner sleeve 12′. It is understood that the inner sleeve 12′ and the outer sleeve 14′ can be interconnected by a separable connecting portion, as described above.

The fastening apparatus 10″ shown in FIG. 5 basically differs from the fastening apparatus 10 of FIGS. 1 to 3 in that the outer sleeve 14 is connected to another fastening portion 30′. In the case of the fastening apparatus 10″, the fastening portion 30′ comprises a lower part, which extends transverse to the longitudinal axis and which may be right-angled for example in plan view, and a correspondingly shaped upper part 68. The lower part 66 and the upper part 68 are interconnected at one of their ends via a hinge 70, for example in the form of an integral hinge. The outer sleeve 14 is formed by the lower part 66 in this case. The upper part 68 has a central opening 52, via which a tool can be introduced to release the latched connection.

To achieve the fastening position, the lower part 66 and the upper part 68 are opened via the hinge 70, and the lower part 66 is pressed onto the inner sleeve 12 by the outer sleeve 40 integrated in said lower part. The upper part 68 can then be folded down onto the lower part 66, one or more receptacles for elongate objects being formed between the lower part 66 and the upper part 68. In the present case, a first receptacle 72 is formed on one side of the longitudinal axis 16, and a second receptacle 74 is formed on the other side of the longitudinal axis. The upper part 68 can be locked to the lower part 66 by means of a catch 76 (not described in greater detail).

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A fastening apparatus for fastening to a spherical stud affixed to a workpiece, the fastening apparatus removable with an unlatching tool, and the fastening apparatus comprises:
an inner sleeve, which can splay out in the radial direction and can be slid over the stud;
an outer sleeve axially slidable over the inner sleeve into a fastening position;
a latching device for releasably joining the outer sleeve to the inner sleeve in the fastening position, the latching device including a latching tongue which engages a latching shoulder in the fastening position, thus forming a latched connection which is secured against release; and
a tool access in one of the outer sleeve and the inner sleeve for insertion of the unlatching tool to disengage the latching tongue from the latching shoulder.

2. A fastening apparatus according to claim 1, wherein the latching tongue is formed on the inner sleeve and the latching shoulder is formed on the outer sleeve.

3. A fastening apparatus according to claim 2, wherein the tool access includes an axially extending radial recess defined by an inner circumference of the outer sleeve.

4. A fastening apparatus according to claim 3, wherein the axially extending radial recess extends from a first axial end of the outer sleeve to the latching shoulder on the outer sleeve.

5. A fastening apparatus according to claim 2, wherein the tool access includes a radial recess defined by an outer circumference of the latching tongue.

6. A fastening apparatus according to claim 1, wherein the latching tongue is formed on the outer sleeve and the latching shoulder is formed on the inner sleeve.

7. A fastening apparatus according to claim 6, wherein the tool access includes an axial recess extending radially through the inner sleeve.

8. A fastening apparatus according to claim 1, wherein the outer sleeve includes a fastening portion.

9. A fastening apparatus according to claim 8, wherein the fastening portion includes a lower part and a pivotable upper part connected to the lower part by a hinge.

10. A fastening apparatus according to claim 1, wherein the tool access includes a radial hole through the outer sleeve.

11. A fastening apparatus according to claim 1, and further comprising an anti-twist protection device including a first anti-twist element on an outer circumference of the inner sleeve which interlocks with a second anti-twist element on an inner circumference of the outer sleeve.

12. A fastening apparatus for fastening to a spherical stud affixed to a workpiece, the fastening apparatus removable with an unlatching tool, and the fastening apparatus comprises:
an inner sleeve substantially tubular and defining a first axial bore, the inner sleeve have an annular first axial end of greater internal diameter and a segmented second axial end of lesser internal diameter which can expand radially around and then contract behind the ball stud when the fastening apparatus is slid axially over the stud;
an outer sleeve substantially tubular and defining a second axial bore, the outer sleeve is axially slidable over the inner sleeve from a pre-assembled position to a fastened position;
a latch for releasably joining the outer sleeve to the inner sleeve in the fastened position, the latch including a latching shoulder and a radially flexible latching tongue which slides over and then interlocks with the latching shoulder as the outer sleeve moves axially over the inner sleeve from the preassembled position to the fastened position; and
a tool access in one of the outer sleeve and the inner sleeve for insertion of the unlatching tool to disengage the latching tongue from the latching shoulder.

13. A fastening apparatus according to claim 12, wherein
the latching tongue is formed on the inner sleeve and is radially flexible inward into the first bore; and
the latching shoulder is formed on an inner circumference of the outer sleeve.

14. A fastening apparatus according to claim 13, wherein the tool access includes a hole defined by and extending radially through the outer sleeve, and through which the unlatching tool may be inserted press the latching tongue radially inward and off the latching shoulder.

15. A fastening apparatus according to claim 13, wherein the tool access includes an axially extending recess defined by one of the inner circumference of the outer sleeve and an outer circumference of the inner sleeve, and the unlatching tool may be inserted axially down the recess to press the latching tongue radially inward.

16. A fastening apparatus according to claim 12, wherein
the latching tongue is formed on the outer sleeve and is radially flexible outward; and
the latching shoulder is formed on an outer circumference of the inner sleeve.

17. A fastening apparatus according to claim 16, wherein the tool access includes a hole defined by and extending radially through the inner sleeve, and through which the unlatching tool may be inserted from the first axial bore in a radially outward direction to press the latching tongue radially outward and off the latching shoulder.
